(19) United States
(12) Patent Application Publication
(10) Pub. No.: US 2025/0071057 A1
(43) Pub. Date: Feb. 27, 2025

(54) ITERATIVE NETWORK ADDRESS TRANSLATION IN A DAISY CHAIN NETWORK

(71) Applicant: Haier US Appliance Solutions, Inc., Wilmington, DE (US)

(72) Inventors: Ryan Michael Hartlage, Crestwood, KY (US); Paul Goodjohn, Crestwood, KY (US)

(21) Appl. No.: 18/456,253

(22) Filed: Aug. 25, 2023

(51) Int. Cl. H04L 45/745; H04L 61/2578

(52) U.S. Cl. CPC H04L 45/745; H04L 61/2578

(57) ABSTRACT

A computer-implemented method for operating a data routing platform of a home appliance is provided. The data routing platform may include a plurality of devices communicatively coupled to a master control board. The computer-implemented method may include receiving, at a device of the plurality of devices, a data packet comprising packet address data. The computer-implemented method may further include determining, at the device, whether the packet address data matches device address data of the device. Responsive to determining the packet address data does not match the device address data of the device, the computer-implemented method may include implementing, at the device, an address translation operation to generate updated packet address data.

### FIELD

Example aspects of the present disclosure generally relate to systems and methods for routing data between devices within home appliances.

### BACKGROUND

Home appliances, such as refrigerators, washing machine, dryers, dishwashers, ovens, microwave ovens, toasters, blenders, coffee markers, air conditioners, heaters, etc., include a variety of embedded systems that function to control various components therein. One example is a control board (e.g., controller) coupled to one or more nodes (e.g., devices), such as circuit boards, by a network interface. To communicate (e.g., exchange information and/or data) with the nodes, the control board sends a data packet to a unique address associated with each of the nodes. The unique address associated with each of the nodes is used by both the control board and nodes to ensure the data packet arrives at its intended location.

### SUMMARY

Aspects and advantages of embodiments of the present disclosure will be set forth in part in the following description, or can be learned from the description, or can be learned through practice of the embodiments.

One example aspect of the present disclosure is directed to an appliance. The appliance may include a user interface and a data routing platform. The user interface may include one or more user inputs. The data routing platform may include a master control board coupled to a network interface. The data routing platform may further include a plurality of devices coupled in a daisy chain topology to form a daisy chain sequence. The daisy chain sequence may be communicatively coupled to the master control board at a pin location of the master control board via the network interface. Each device of the plurality of devices may be configured to perform data routing operations. For each device of the plurality of devices, the data routing operations may include: receiving a data packet comprising packet address data, the packet address data comprising a destination address corresponding to an intended receiving device of the data packet and a source address corresponding to a source device of the data packet; determining whether the destination address of the packet address data matches device address data corresponding to the device, the device address data comprising a physical address corresponding to the pin location at which the daisy chain sequence is coupled to the master control board; and responsive to determining the destination address of the address data does not match the physical address of the device address data, implementing an address translation operation to generate updated packet address data.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a perspective view of an example home appliance according to example embodiments of the present disclosure;

FIG. 2 depicts a top view of an example home appliance according to example embodiments of the present disclosure;

FIG. 3 depicts a close-up view of a control input of the home appliance of FIG. 2 according to example embodiments of the present disclosure;

FIG. 4 depicts a block diagram of an example data routing platform according to example embodiments of the present disclosure;

FIG. 5 depicts an example data packet according to example embodiments of the present disclosure;

FIG. 6 depicts a block diagram of an example data routing platform according to example embodiments of the present disclosure;

FIG. 7 depicts a flow chart diagram of an example method according to example embodiments of the present disclosure;

FIG. 8 depicts a flow chart diagram of an example method according to example embodiments of the present disclosure; and

FIG. 9 depicts a flow chart diagram of an example method according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure generally relate to systems and methods for routing data between devices within home appliances. In particular, example aspects of the present disclosure provide an address translation method for a data routing platform in a home appliance. The data routing platform may include a master control board coupled to a network interface, such as a Universal Asynchronous Receiver/Transmitter (UART). The data routing platform may further include a plurality of devices, such as a plurality of circuit boards, communicatively coupled to the master control board.

When designing appliances (and component parts thereof), there is value in reducing the number of unique devices (e.g., unique circuit boards). Reducing the number of unique devices results in reduced part counts during both production of the appliance and service of the appliance. Reducing the number of unique devices also results in a reduced number of unique firmware images necessary for the various devices of the appliance, which is also valuable. By reducing the number of unique firmware images, separate firmware images do not need to be released for each device in the appliance. Moreover, there is also value in implementing a daisy chain network between the devices in the appliance, because a daisy chain topology reduces the number of network interfaces (e.g., UARTs) on each board (e.g., master control board). Reducing the number of network interfaces, in turn, reduces hardware costs and increases design flexibility. For example, daisy chain networks provide the ability to add additional devices to the network with fewer constraints.

Accordingly, as will be discussed in greater detail below, example aspects of the present disclosure are directed to a data routing platform having a plurality of devices coupled in a daisy chain topology. As such, the plurality of devices may form a daisy chain sequence of devices. As used herein, a daisy chain sequence generally refers to a wiring scheme in which multiple devices are wired together in a sequence, similar to a garland of daisy flowers. The master control board and the daisy chain sequence may, together, form a daisy chain network.

Additionally, each device of the daisy chain sequence may be an identical device. More particularly, each device of the plurality of devices may include the same hardware and the same firmware. As such, each individual device of the daisy chain sequence may include the same firmware image as the other devices of the daisy chain sequence. In this manner, example aspects of the present disclosure provide a modular and extensible data routing platform for an appliance.

As noted above, the plurality of devices may be communicatively coupled to the master control board. More particularly, a daisy chain sequence (e.g., the plurality of devices) according to example aspects of the present disclosure may be communicatively coupled to the master control board via the network interface. In this manner, the master control board may be configured to communicate (e.g., transmit data, receive data) with the plurality of devices of the daisy chain sequence.

In order to communicate the individual devices of the daisy chain sequence, each individual device must be uniquely addressed because, as noted above, each device of the daisy chain sequence may be an identical device having identical hardware and firmware. Otherwise, the components of the data routing platform, such as the master control board and the plurality of devices, will not be able to properly transmit data or receive data. More particularly, unless each device is uniquely addressed, the components of the daisy chain sequence will be unable to ensure a transmitted data packet will be sent to and/or arrive at the correct node (e.g., device). Thus, address determination and address assignment are crucial for ensuring that the devices within the appliance are able to properly communicate.

Conventional address determination and assignment methods often involve often involve a combination of hardware and software solutions. For instance, the most basic way to assign unique addresses to a plurality of identical nodes is through hardcoding. However, hardcoding is not a practical solution, especially considering the design considerations set forth above. Alternatively, unique addresses may be assigned by leveraging identifying information in the harness of each node and/or through software provisioning. For instance, unique addresses may be written into parametric data of the boot loader, or a model plug may be used. However, these methods may increase production and service costs, increase a pin count for the master control board, add additional steps in production and service, create failure modes (e.g., associated with missing, incorrect, failed, or defective software and/or hardware), etc. Thus, a pure software solution having no additional production and/or service requirements is preferable to these conventional methods.

Accordingly, example aspects of the present disclosure are directed to a data routing platform for a home appliance. As noted above, the data routing platform according to example aspects of the present disclosure may include a master control board coupled to a network interface. The data routing platform may further include a plurality of devices coupled in a daisy chain topology to form a daisy chain sequence that is communicatively coupled to the master control board via the network interface. As such, each device of the plurality of devices may have the same physical address (e.g., connection location) with respect to the master control board. As will be discussed in greater detail below, the master control board may be configured to speak to each of the plurality of peripheral devices using a known, unique logical address known only to the master control board, thereby allowing the master control board to communicate with each peripheral device independently.

As noted above, each device of the plurality of devices is an identical device. In other words, each device has identical hardware, identical firmware, and identical physical addresses within the appliance. As such, the data routing platform described herein may be configured to perform data routing operations, including address determination and assignment operations, without requiring additional hardware.

More particularly, example aspects of the present disclosure are further directed to a computer-implemented method for operating the data routing platform. As will be discussed in greater detail below, a device of the plurality of devices may receive a data packet from another device of the plurality of devices and/or the master control board. In some embodiments, the data packet may include packet address data, such as a destination address and a source address. The destination address may identify the intended recipient of the data packet, and the source address may identify the device from which the data packet originates (e.g., the source device).

Furthermore, upon receipt of the data packet, the device may determine whether the packet address data matches device address data of the device. The device address data for each of the devices may include the physical address of the device, which, as noted above, corresponds to the pin location at which the daisy chain sequence (e.g., the plurality of devices) is coupled to the master control board. Thus, the device may be configured to determine whether the destination address of the data packet matches the physical address known to the device.

When the destination address of the data packet matches its known physical address, the device may generate and transmit a response packet. The device may transmit the response packet to an adjacent device that is in an up-chain direction from the device. As used herein, the “up-chain” direction is a direction moving towards the master control board along the daisy chain sequence. It should be noted that, depending on where the device is located along the daisy chain sequence, the adjacent device (e.g., the up-chain device) may be another device of the daisy chain sequence, or the adjacent device (e.g., the up-chain device) may be the master control board.

Conversely, when the destination address of the of the data packet does not match its known physical address, the device may implement an address translation operation to generate updated packet address data. As will be described in greater detail below, the devices of the daisy chain sequence may be configured to iteratively translate the physical addresses associated with the devices to match the logical address known by the master control board. More particularly, the device may determine whether the source device of the data packet is another device of the daisy chain sequence or whether the source device of the data packet is the master control board. As noted above, the packet address data of the data packet includes a source address identifying the origin of the data packet.

When the source device of the data packet is the master control board, the device may decrement the destination address of the packet address data to generate the updated packet address data, which includes an updated destination address of the data packet. Responsive to decrementing the destination address and generating the updated packet address data, the device may transmit the data packet to an adjacent device that is in a down-chain direction from the device. As used herein, the “down-chain” direction is a direction moving away from the master control board along the daisy chain sequence.

When the source device of the data packet is another device in the daisy chain sequence, the device may increment the source address of the packet address data to generate the updated packet address data, which includes an updated source address of the data packet. Responsive to incrementing the source address and generating the updated packet address data, the device may transmit the data packet to an adjacent device that is in an up-chain direction from the device. As noted above, the “up-chain” direction is a direction moving towards the master control board along the daisy chain sequence, and, depending on where the device is located along the daisy chain sequence, the adjacent device (e.g., the up-chain device) may be the master control board or another device of the daisy chain sequence.

Example aspects of the present disclosure provide numerous technical effects and benefits. For instance, example aspects of the present disclosure provide a data routing platform having a daisy chain network topology. As such, example aspects of the present disclosure reduce the number of network interfaces necessary for the data routing platform which, in turn, reduces hardware costs. Furthermore, example aspects of the present disclosure provide a modular and extensible data routing platform. In this manner, example aspects of the present disclosure provide increased design flexibility, thereby allowing for more devices to be added to the data routing platform with fewer constraints. Furthermore, by including a plurality of devices having identical hardware and firmware, the number of unique boards and firmware images in the data routing platform is reduced, thereby reducing part counts for production and service. Moreover, the identical devices also contributes to the increased design flexibility. Furthermore, the data routing operations provided herein allow the master control board to independently communicate with each of the plurality of devices, all of which having the same physical address. In this manner, the need for, e.g., jumpers, address provisioning, etc. is eliminated. Failure modes during production and during service calls are also eliminated.

In sum, the systems and methods described herein allow for the benefits of a daisy chained network of identical devices, without requiring the use of a model plug, identifiers in the harnesses, or any additional software provisioning steps. In this manner, the systems and methods of the present disclosure reduce the physical complexity, reduce the material costs, reduce the process costs, eliminate the failure modes, and reduce the cost of quality (CoQ) for the associated appliance.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

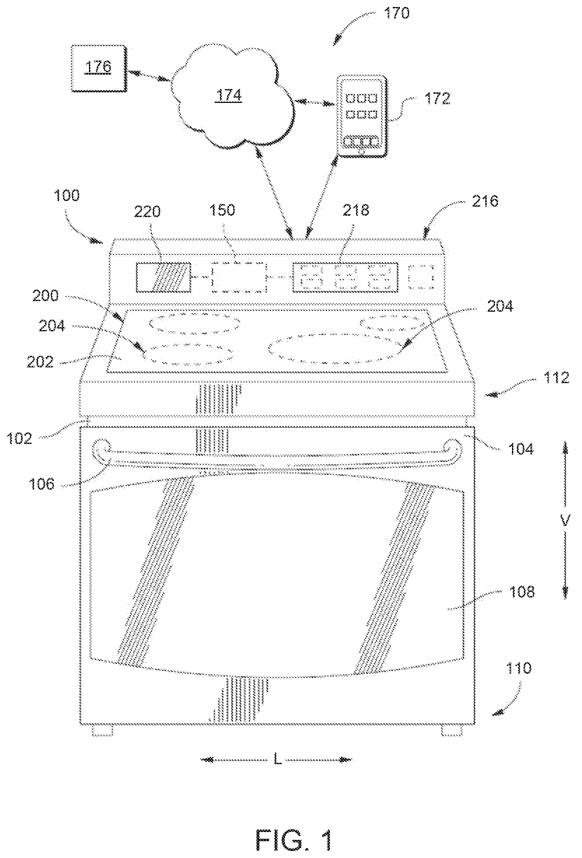

FIG. 1 provides a perspective view of an oven appliance (or cooking appliance) 100 according to an exemplary embodiment of the present disclosure. Oven appliance 100 is provided by way of example only and is not intended to limit the present subject matter in any aspect. Other oven or range appliances having different configurations, different appearances, or different features may also be utilized with the present subject matter as well (e.g., double ovens, electric cooktop ovens, stand-alone ovens, etc.). Thus, the present subject matter may be used with other cooking appliance configurations (e.g., that define one or more cooktop surfaces including a plurality of heating elements or burners). Further, the present subject matter may be used in a stand-alone cooktop, range appliance, or any other suitable appliance. Even further, the present subject matter (e.g., data routing platform 300) may find application in any suitable home appliance, such as refrigerators, washing machine, dryers, dishwashers, ovens, microwave ovens, toasters, blenders, coffee markers, air conditioners, heaters, etc., without deviating from the scope of the present disclosure.

Oven appliance 100 generally includes a cooking assembly. In particular, the cooking assembly may include one or more heating elements. For example, in some embodiments, the cooking assembly, and thus the oven appliance 100, includes an insulated cabinet 102 with an interior cooking chamber defined by an interior surface of cabinet 102. The cooking chamber may be configured for the receipt of one or more food items to be cooked. The cooking chamber may be defined by a back wall, a top wall, and a bottom wall spaced from the top wall along the vertical direction V by opposing side walls (e.g., a first wall and a second wall).

In some embodiments, a gas fueled or electric bottom heating element (e.g., a gas burner, a resistive heating element, resistance wire elements, radiant heating element, electric tubular heater or CALROD®, halogen heating element, etc.) (not shown) is positioned in cabinet 102, for example, at a bottom portion 110 of cabinet 102. Additionally, in some embodiments, a top heating element (e.g., a gas burner) (not shown) is positioned in the interior cooking chamber of cabinet 102, for example, at a top portion 112 of cabinet 102.

Oven appliance 100 may include a door 104 rotatably mounted to cabinet 102 (e.g., with a hinge—not shown). A handle 106 may be mounted to door 104 and assists a user with opening and closing door 104 in order to access the cooking chamber. For example, a user can pull on handle 106 to open or close door 104 and access the cooking chamber. Furthermore, multiple parallel glass panes 108 may provide for viewing the contents of the interior cooking chamber.

Generally, oven appliance 100 may include a controller 150 in operative

communication (e.g., operably coupled via a wired or wireless channel) with one or more other portions of oven appliance 100 (e.g., heating elements) via, for example, one or more signal lines or shared communication busses, and signals generated in controller 150 operate oven appliance 100 in response to user input via user inputs 218. Input/Output (“I/O”) signals may be routed between controller 150 and various operational components of oven appliance 100 such that operation of oven appliance 100 can be regulated by controller 150. In addition, controller 150 may also be in operative communication (e.g., wired or, alternatively, wireless communication) with one or more sensors, such as a first temperature sensor or a second temperature sensor. Generally, either or both the first temperature sensor and the second temperature sensor may include or be provided as a thermistor or thermocouple, which may be used to measure temperature at a location within or proximate to the cooking chamber, for example, and provide such measurements to the controller 150. As will be discussed in greater detail below, the controller 150 may be part of a data routing platform (e.g., data routing platform 300). More particularly, the controller 150 may be configured to independently communicate with a plurality of nodes, such as a plurality of circuit boards coupled to various components within the oven appliance 100.

Controller 150 is a “processing device” or “controller 150” and may be embodied as described herein. Controller 150 may include a memory and one or more microprocessors, microcontrollers, application-specific integrated circuits (ASICS), CPUs or the like, such as general or special purpose microprocessors operable to execute programming instructions or micro-control code associated with operation of oven appliance 100, and controller 150 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Referring still to FIG. 1, a schematic diagram of an external communication system 170 will be described according to an exemplary embodiment of the present subject matter. In general, external communication system 170 is configured for permitting interaction, data transfer, and other communications between appliance 100 and one or more external devices. For example, this communication may be used to provide and receive operating parameters, user instructions or notifications, performance characteristics, user preferences, or any other suitable information for improved performance of appliance 100. In addition, it should be appreciated that external communication system 170 may be used to transfer data or other information to improve performance of one or more external devices or appliances and/or improve user interaction with such devices.

For example, external communication system 170 permits controller 150 of appliance 100 to communicate with a separate device external to appliance 100, referred to generally herein as an external device 172. As described in more detail below, these communications may be facilitated using a wired or wireless connection, such as via a network 174. In general, external device 172 may be any suitable device separate from appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device. Additionally or alternatively, with respect to embodiments described herein, external device may be a cookware item.

In addition, a remote server 176 may be in communication with appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control appliance 100, etc. In addition, external device 172 and remote server 176 may communicate with appliance 100 to communicate similar information.

In general, communication between appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Oven appliance 100 may include a cooktop 200. Cooktop 200 may be disposed on the cabinet 102 such that the total volume of cabinet 102 is generally divided between the cooking chamber and cooktop 200. As shown, cooktop 200 may include a top panel 202. By way of example, top panel 202 may be constructed of glass, ceramics, enameled steel, and combinations thereof. Heating assemblies 204 (e.g., induction heating elements, resistive heating elements, radiant heating elements, or gas burners) may be mounted, for example, on or below the top panel 202. While shown with four heating assemblies 204 in the exemplary embodiment of FIG. 1, cooktop appliance 100 may include any number of heating assemblies 204 in alternative exemplary embodiments. Heating assemblies 204 can also have various diameters. For example, each heating assembly of heating assemblies 204 can have a different diameter, the same diameter, or any suitable combination thereof. Moreover, one or more of the heating assemblies 204 may have varying diameters (e.g., multiple concentric rings offering different power levels and/or heat production).

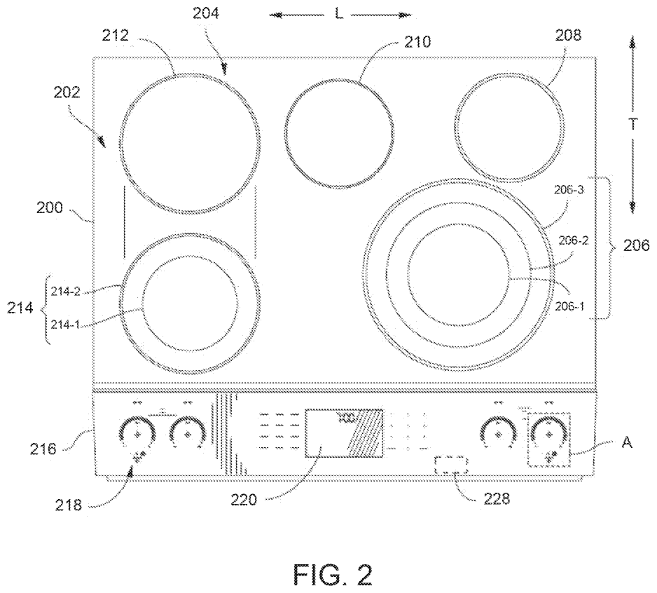

As shown, certain embodiments of oven appliance 100 include a user interface panel 216, which may be located as shown, within convenient reach of a user of the oven appliance 100. User interface panel 216 is generally a component that allows a user to interact with the oven appliance 100 to, for example, turn various heating elements (such as heating elements 204) on and off, adjust the temperature of the heating elements, set built-in timers, etc. Although user interface panel 216 is shown in FIG. 1 as being mounted to a backsplash fixed to cabinet 102, alternative embodiments may provide user interface panel 216 at another suitable location (e.g., on a front portion of cabinet 102 above door 104, as seen in FIG. 2).

In some embodiments, a user interface panel 216 may include one or more user-interface inputs 218 and a graphical display 220, which may be separate from or integrated with the user-interface inputs 218. The user-interface inputs 218 may include analog control elements (e.g., knobs, dials, or buttons) or digital control elements, such as a touchscreen comprising a plurality of elements thereon. Various commands for a user to select through the engagement with the user-interface inputs 218 may be displayed (e.g., by touchscreen at the inputs 218 or by the graphical display 220), and detection of the user selecting a specific command may be determined by the controller 150, which is in communication with the user-interface inputs 218, based on electrical signals therefrom. Additionally or alternatively, graphical display 220 may generally deliver certain information to the user, which may be based on user selections and interaction with the inputs 218, such as whether one or more heating elements within the cooking chamber are activated or the temperature at which the cooking chamber is set.

FIG. 2 provides a top view of an exemplary cooktop 200 and user interface panel 216 according to at least one embodiment of the present disclosure. As seen in FIG. 2, user interface panel 216 may be provided at or near a front of cooktop 200 (e.g., along a transverse direction T). Moreover, according to the embodiment shown in FIG. 2, cooktop 200 includes five burners (e.g., heating assemblies 204) spatially arranged thereon. As described above, cooktop 200 may include top panel 202 on which heating assemblies 204 are arranged. According to this example, the plurality of heating assemblies 204 are induction heating elements 204. Additionally or alternatively, at least some of the induction heating elements 204 may be variable in diameter.

Each of the plurality of heating elements 204 may be capable of providing selective levels of heat output (or power output for induction elements). In detail, a user may adjust a power level of a selected burner (or burner diameter) according to a desired heat level. Accordingly, a user may select first burner 206 at a first diameter (e.g., a first diameter 206-1, a second diameter 206-2, or a third diameter 206-3). While first diameter 206-1 outputs a first level of heat (e.g., at full power) that is less than an output of, for example, first diameter 206-1 and a second diameter 206-2 together, the user may adjust a total heat output of just the first diameter 206-1 (e.g., via user interface panel 216, described below). Additionally or alternatively, a combination of heating elements 204 may be activated by the user. For example, the user can activate fourth element 212 and fifth element 214 (e.g., at a first diameter 214-1 or a second diameter 214-2) simultaneously to create a griddle burner. It should be understood that any suitable activation level or intensity of a selected burner (or burner diameter), as well as any suitable combination of burners or heating elements may be activated according to specific embodiments.

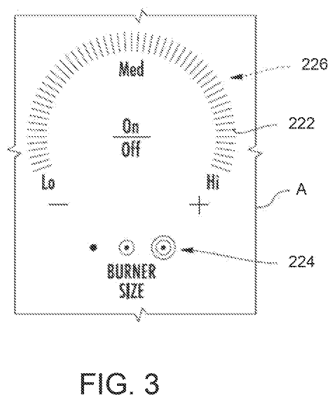

User interface panel (or control panel) 216 may include one or more user inputs 218. As discussed above, user inputs 218 may be analog or digital, or a combination thereof. For the embodiment described herein, user inputs 218 are touch inputs on user interface panel 216. Accordingly, user interface panel 216 may be referred to as a touch panel. User interface panel 216 may include a plurality of inputs 218, e.g., one for each burner (first burner 206, second burner 208, third burner 210 etc.). Inputs 218 may be spaced apart from each other along user interface panel 216. For instance, inputs 218 may be spaced apart along the lateral direction L. An exemplary input 218 is shown in subset A, which is provided in FIG. 3.

Input 218 may include a plurality of interactive controls. For instance, input 218 may include a power slider 222. As shown, power slider 222 may be provided as a semi-circular arc on touch panel 216. A user may adjust a power input to the respective burner by sliding a finger along the power slider 222. Additionally or alternatively, input 218 may include a burner size selector 224. As shown in FIG. 3, burner size selector 224 may include one or more indicators indicating a burner size (e.g., burner diameter). Using first burner 206 as an example, burner size selector 224 may include a first indicator with a single ring, a second indicator with two rings, and a third indicator with three rings. Burner size selector 224 may selectively illuminate or otherwise accentuate one or more of the plurality of indicators associated with the activated burner diameters. For at least one example, a user selects first burner 206 with first diameter 206-1 and second diameter 206-2 activated. Accordingly, burner size selector 224 illuminates or accentuates the second indicator to indicate that the first diameter 206-1 and the second diameter 206-2 are actively producing heat. Accordingly, a user may select which burner diameters will be active during a cooking operation.

User interface panel 216 may include one or more light sources 226. According to some embodiments, light sources 226 are provided behind (e.g., underneath) user inputs 218. For instance, each of power slider 222 and burner size selector 224 may have a dedicated light source which illuminates a selected portion of input 218 at a selected time. Additionally or alternatively, one or more light sources may be provided on an external surface of user interface panel 216. For instance, one or more light emitting diodes (LEDs) may be provided at or near user inputs 218 or display 220. Moreover, the one or more light emitting diodes may be activated independently from an operation or interaction with user inputs 218 or display 220.

Cooktop 200 may include a speaker 228. For instance, speaker 228 may be any suitable noise maker, such as a transducer, a buzzer, a bell, or the like. Speaker 228 may be selectively controlled by controller 150. Activation of speaker 228 may be combined with an activation of one or more of light sources 226.

Display 220 may be a digital display. For instance, display 220 may be a liquid crystal display (LCD) or any other suitable interactive display. Accordingly, display 220 may present one or more complex images associated with appliance 100 (e.g., cooktop 200). According to one embodiment, display 220 displays a plurality of rings associated with the plurality of heating elements 204 and burner diameters. Again referring to first burner 206 as an example, display 220 displays first burner 206 as three concentric circles representing first diameter 206-1, second diameter 206-2, and third diameter 206-3. Display 220 may selectively illuminate or otherwise accentuate one or more of the plurality of rings associated with the activated burner diameters. For at least one example, a user selects first burner 206 with first diameter 206-1 and second diameter 206-2 activated. Accordingly, display 220 illuminates or accentuates a first ring and a second ring to indicate that the first diameter 206-1 and the second diameter 206-2 are actively producing heat.

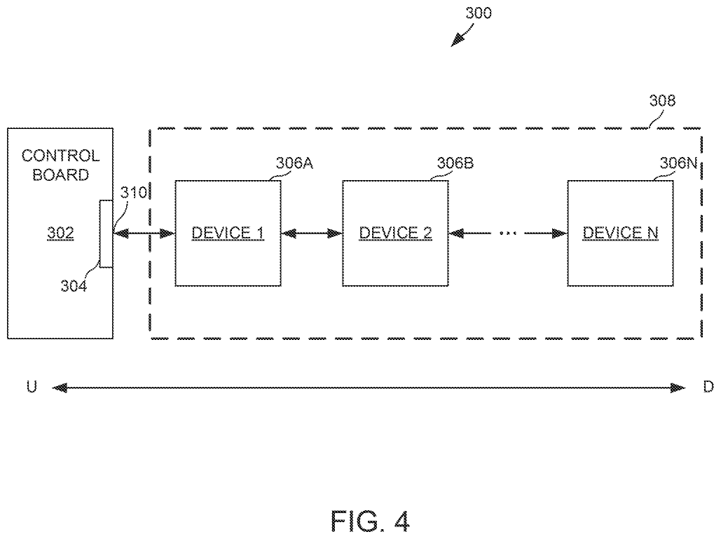

Referring now to FIG. 4, an example data routing platform 300 is depicted according to example embodiments of the present disclosure. In some embodiments, the data routing platform 300 may be used implemented in a home appliance, such as oven appliance 100 (FIG. 1) or cooktop 200 (FIGS. 1-3). It should be noted that data routing platform 300 is discussed herein as being implemented in an induction cooktop appliances for purposes of illustration and discussion and is not intended to limit the implementations of the data routing platform 300 described herein. Those having ordinary skill in the art, using the disclosures provided herein, will understand that data routing platform 300 may be implemented in any suitable home appliance without deviating from the scope of the present disclosure.

The data routing platform 300 may include a master control board 302. In some embodiments, the data routing platform 300 include, e.g., the controller 150 (FIGS. 1-3). As shown, the master control board 302 may be coupled to a network interface 304. More particularly, the network interface 304 may be any suitable serial network interface, such as Universal Asynchronous Receiver/Transmitter (UART). In some embodiments, the network interface 304 (e.g., UART) may be integral to the master control board 302. In other embodiments, the network interface 304 may be external (e.g., hardware chip) to the master control board 302. Furthermore, the master control board 302 may include a single network interface 304, such as a single UART. It should be noted that the network interface 304 is discussed herein as being a UART for purposes of illustration and discussion. Those having ordinary skill in the art, using the disclosures provided herein, will understand that network interface 304 may be any suitable network interface without deviating from the scope of the present disclosure.

The data routing platform 300 may further include a plurality of devices 306 (e.g., circuit boards) having identical hardware and identical firmware. The plurality of devices 306 (e.g., device 306A, 306B, . . . 306N) may be coupled in a daisy chain topology to form a daisy chain sequence 308. The daisy chain sequence 308 may define an up-chain direction U and a down-chain direction D with respect to each device 306 (e.g., device 306A, 306B, . . . 306N). More particularly, the up-chain direction U is a direction moving towards the master control board 302 along the daisy chain sequence 308. Conversely, the down-chain direction D is a direction moving away from the master control board 302. For instance, the master control board 302 is located in an up-chain direction D from device 306A, and device 306B is located in a down-chain direction from device 306A.

As shown, the daisy chain sequence 308 may be coupled to the master control board 302 at a pin location 310 of the master control board. More particularly, the network interface 304 may couple the daisy chain sequence to the master control board 302 at the pin location 310 on the master control board 302. Each device 306 (e.g., device 306A, 306B, . . . 306N) may be configured to perform data routing operations. For instance, as will be discussed in greater detail below, each device 306 (e.g., device 306A, 306B, . . . 306N) may be configured to receive a data packet having packet address data.

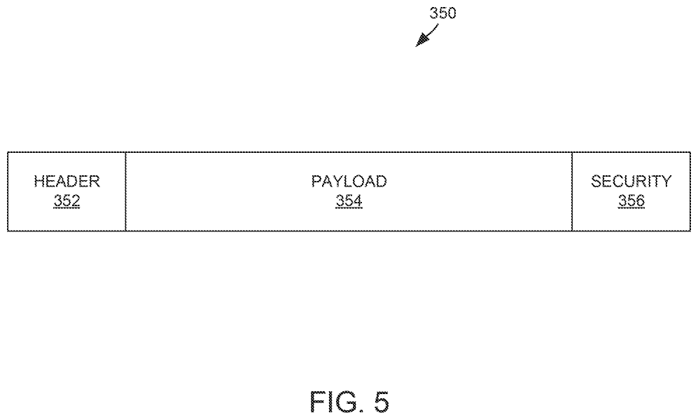

As an illustrative example, FIG. 5 depicts an example data packet 350 according to example embodiments of the present disclosure. Data packet 350 may include a plurality of frames each having a plurality of data bits. For instance, as shown, the data packet 350 may include a header 352. The header 352 may include the packet address data. More particularly, the packet address data may include a destination address corresponding to an intended receiving device of the data packet 350. The packet address data may also include a source address corresponding to a source device of the data packet 350. In this manner, header 352 may be a unique identifier of the data packet 350.

Furthermore, header 352 may enable delivery of a payload 354 to the intended receiving device. More particularly, the destination address of the header 352 may identify the intended receiving device. The payload 354 may include the portion of the data packet 350 that is the actual intended message. The data packet 350 may further include a security frame 356, such as a cyclic redundancy checking (CRC) formula. The security frame 356 is an added error detection frame for the data packet 350.

Referring again to FIG. 4, because each device 306 (e.g., device 306A, 306B, . . . 306N) is identical, each device 306 in the daisy chain sequence 308 has a stored physical address corresponding to the pin location 310. However, as will be discussed in greater detail below, the master control board 302 may assign a unique logical address to each device 306 (e.g., device 306A, 306B, . . . 306N) to allow for independent communication with each device 306 (e.g., each node of the daisy chain sequence 308).

Because the logical address are unknown to the individual devices, each device 306 (e.g., device 306A, 306B, . . . 306N) may be configured to implement address translation operations to ensure the data packet 350 (FIG. 5) arrives at the correct intended receiving device. For instance, each device 306 (e.g., device 306A, 306B, . . . 306N) may be further configured to determine whether the destination address of the packet address data matches device address data corresponding to the particular device 306 (e.g., device 306A, 306B, . . . 306N). More particularly, the device address data may include the physical address that corresponds to the pin location 310 at which the daisy chain sequence 308 is coupled to the master control board 302.

In response to determining the destination address of the data packet 350 (FIG. 5) matches its physical address, the device 306 (e.g., device 306A, 306B, . . . 306N) may be generate a response packet. The response packet may have a similar structure as the data packet 350 described with reference to FIG. 5. Furthermore, the device 306 (e.g., device 306A, 306B, . . . 306N) may then transmit the response packet to an adjacent device in an up-chain direction from the device 306 (e.g., device 306A, 306B, . . . 306N).

Conversely, in response to determining the destination address of the data packet 350 (FIG. 5) does not match its physical address, the device 306 (e.g., device 306A, 306B, . . . 306N) may implement an address translation operation to the data packet 350 (FIG. 5) to generate updated packet address data. More particularly, in response to determining the destination address of the data packet 350 (FIG. 5) does not match its physical address, the device 306 (e.g., device 306A, 306B, . . . 306N) may determine the source device of the data packet based on the source address of the packet address data.

In response to determining the source device is the master control board 302, the device 306 (e.g., device 306A, 306B, . . . 306N) may decrement the destination address of the packet address data to generate the updated packet address data. The updated packet address data may include an updated destination address of the data packet. Furthermore, after decrementing the destination address of the packet address data, the device 306 (e.g., device 306A, 306B, . . . 306N) may transmit the data packet having the updated packet address data to an adjacent device in the down-chain direction D from the device 306 (e.g., device 306A, 306B, . . . 306N).

In response to determining the source device is another device 306 (e.g., device 306A, 306B, . . . 306N) in the daisy chain sequence 308, the device 306 (e.g., device 306A, 306B, . . . 306N) may increment the source address of the packet address data to generate the updated address data. The updated packet address data may include an updated source address of the data packet. Furthermore, after incrementing the source address of the packet address data, the device 306 (e.g., device 306A, 306B, . . . 306N) may transmit the data packet having the updated packet address data to an adjacent device in the up-chain direction U from the device 306 (e.g., device 306A, 306B, . . . 306N).

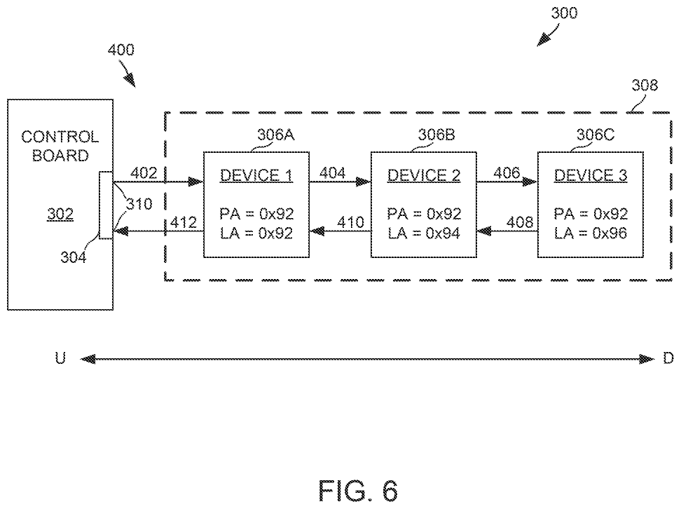

Referring now to FIG. 6, the data routing platform 300 performing an example data routing operation 400 is depicted according to example embodiments of the present disclosure. It should be noted that the data routing operations 400 depicted in FIG. 6 are for purposes of illustration and discussion and are not intended to be a limiting example of the data routing operations disclosed herein.

As noted above, the data routing platform 300 may include the master control board 302 communicatively coupled to a daisy chain sequence 308 (e.g., devices 306A, 306B, 306C). More particularly, the daisy chain sequence 308 may be communicatively coupled to the master control board 302 at pin location 310 via the network interface 304. As noted above, because each device 306 has identical hardware and identical firmware, each device 306 believes its respective physical address (PA) corresponds to the pin location 310. Thus, in order to communicate with each device 306 individually, the master control board 302 must address communications for each device 306 using a unique logical address (LA). However, because each device 306 does not know its corresponding logical address (LA) known by the master control board 302, each device 306 is configured to perform data routing operations, such as the data routing operations 400, to iteratively translate the known physical addresses to logical addresses.

As shown, devices 306A, 306B, 306C each have a physical address of 0x92, which may correspond to the pin location 310. As such, the master control board 302 may use unique logical addresses to the devices 306A, 306B, 306C. More particularly, the master control board 302 may use a logical address of 0x92 to communicate with device 306A, the master control board 302 may use a logical address of 0x94 to communicate with device 306B, and the master control board 302 may use a logical address of 0x96 to communicate with device 306C.

For purposes of illustration and discussion, FIG. 6 depicts the example data routing operations 400 performed by the data routing platform 300 where the master control board 302 attempts to send a data packet (e.g., data packet 350) to the device 306C. More particularly, to send the data packet to device 306C, the destination address of the data packet may be 0x96 (e.g., the logical address corresponding to the device 306C). It should be noted, however, that the data routing operations 400 may be performed by any device and/or control board to send a data packet to any other device and/or control board of the data routing platform 300.

At 402, the master control board 302 may transmit a data packet to the first node of the daisy chain sequence 308 via the network interface 304, and the data packet may have a destination address corresponding to the logical address of device 306C. More particularly, the master control board 302 may transmit the data packet to the device 306A. Upon receipt of the data packet, the device 306A may determine whether the destination address of the data packet matches the physical address associated with the device 306A. However, as shown, the physical address of the device 306A (0x92) does not match the destination address (0x96) of the data packet. Thus, in response, the device 306A may perform address translation operations. More particularly, because the device 306A received the data packet from the master control board 302, the device 306A may decrement the destination address of the data packet to generate an updated destination address for the data packet. In this example, the device 306A may decrement the destination address (0x96) to generate an updated destination address (0x94).

At 404, the device 306A may transmit the data packet having the updated destination address (0x94) to the device 306B. As shown, the device 306B is an adjacent device to the device 306A in a down-chain direction D along the daisy chain sequence 308. In a similar manner as described above, upon receipt of the data packet from the device 306A, the device 306B may determine whether the destination address of the data packet (0x94) matches the physical address associated with the device 306B (0x92). Because the destination address and physical address do not match, the device 306B may be configured to perform similar operations to those set forth above. In particular, because the source device of the data packet is the master control board 302, the device 306B may decrement the destination address (0x94) to generate an updated destination address (0x92).

At 406, the device 306B may transmit the data packet having the updated destination address (0x92) to device 306C. As shown, device 306C is an adjacent device to device 306B in a down-chain direction D along the daisy chain sequence 308. Furthermore, as noted above, device 306C is the intended receiving device of the data packet. Upon receipt of the data packet from device 306B, the device 306C may determine whether the destination address of the data packet (0x92) matches the physical address associated with the device 306C (0x92). Because the destination address and the physical address do match, the device 306C may generate a response packet. The response packet may have a similar format to the data packet described above with reference to FIG. 5. More particularly, the response packet may have a source address and a destination address. The device 306C may set the destination address as the master control board 302. However, because the device 306C does not know its unique logical address (0x96), the source address of the response packet is set as the known physical address of the device 306C (0x92).

At 408, the device 306C may transmit the response packet to device 306B. As shown, device 306B is an adjacent device to device 306C in an up-chain direction U along the daisy chain sequence 308. Upon receipt of the response packet from device 306C, the device 306B may determine whether the destination address of the response packet matches the physical address associated with the device 306B. However, as noted above, the destination address of the response packet corresponds to the master control board 302. Thus, in response, the device 306B may perform address translation operations. More particularly, because the device 306B received the data packet from the another device (device 306C) in the daisy chain sequence 308, the device 306B may increment the source address of the data packet to generate an updated source address for the data packet. In this example, the device 306B may increment the source address (0x92) to generate an updated source address (0x94).

At 410, the device 306B may transmit the response packet having the updated source address to device 306A. As shown, device 306A is an adjacent device to device 306B in an up-chain direction U along the daisy chain sequence 308. Upon receipt of the response packet from device 306B, the device 306A may determine whether the destination address of the response packet matches the physical address associated with device 306A. However, as noted above, the destination address of the response packet corresponds to the master control board 302. Thus, in response, the device 306A may perform address translation operations. More particularly, because the device 306A received the data packet from the another device (device 306A) in the daisy chain sequence 308, the device 306A may increment the source address of the data packet to generate an updated source address for the data packet. In this example, the device 306A may increment the source address (0x94) to generate an updated source address (0x96).

At 412, the device 306A may transmit the response packet having the updated source address to the master control board 302. As shown, the master control board 302 is an adjacent device to device 306A in an up-chain direction U along the daisy chain sequence 308. Furthermore, as noted above, the master control board 302 is the intended receiving device of the data packet. Because the devices 306A, 306B performed the address translation operations to the source address, the response packet identifies the logical address (0x96) associated with device 306C as the source address of the response packet. In this manner, the master control board 302 is able to know that the data packet was successfully received by device 306C, despite each device 306A, 306B, 306C having the same physical addresses (0x92). As such, the master control board 302 is able to independently communicate with each device 306A, 306B, 306C in the daisy chain sequence 308.

It should be noted that the data routing operations 400 depicted in FIG. 6 may be implemented in a data routing platform 300 having any suitable number of nodes (e.g., devices 306). FIG. 6 depicts three devices 306A, 306B, 306C for purposes of illustration and discussion. Those having ordinary skill in the art, using the disclosures provided herein, will understand that the data routing operations disclosed herein may be implemented in a data routing device having any suitable number of nodes (e.g., devices).

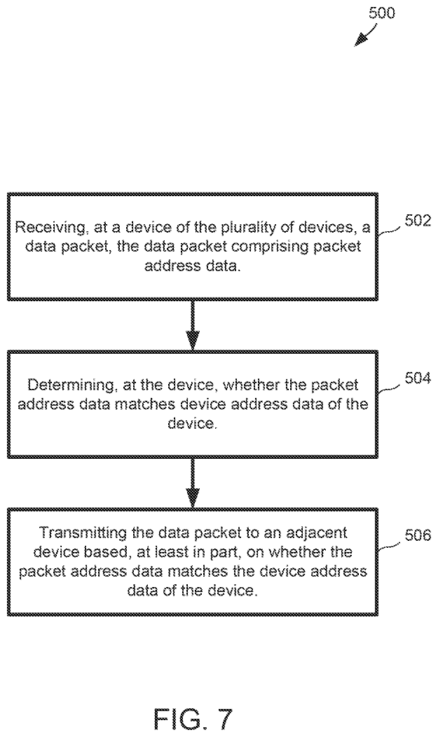

FIG. 7 depicts a flow diagram of an example computer-implemented method 500 for operating a data routing platform of a home appliance according to example embodiments of the present disclosure. More particularly, method 500 may be implemented with any suitable data routing platform, such as data routing platform 300 (FIGS. 4-6), in any suitable home appliance, such as cooking appliance 100 (FIG. 1) or cooktop 200 (FIGS. 2-3). FIG. 5 depicts steps performed in a particular order for purposes of illustration and discussion. Those of ordinary skill in the art, using the disclosures provided herein, will understand that various steps of any of the methods described herein can be omitted, expanded, performed simultaneously, rearranged, and/or modified in various ways without deviating from the scope of the present disclosure. Furthermore, various steps (not illustrated) can be performed without deviating from the scope of the present disclosure. Additionally, method 500 is generally discussed with reference to the data routing platform 300 described above with reference to FIGS. 4-6. However, it should be understood that aspects of the present method 500 may find application with any suitable data routing platform in any suitable home appliance.

At (510), the method 500 may include receiving, at a device of the plurality of devices, a data packet, the data packet comprising packet address data. More particularly, a data routing platform (e.g., data routing platform 300) may include a plurality of devices (e.g., device 306A, 306B, . . . 306N) communicatively coupled to a master control board (e.g., master control board 302). Each device may be communicatively coupled in a daisy chain topology to form a daisy chain sequence (e.g., daisy chain sequence 308), and the daisy chain sequence may be coupled to the master control board at a pin location (e.g., pin location 310) via a network interface (e.g., network interface 304). Furthermore, each device may include identical hardware and identical firmware. Each device may be configured to receive a data packet (e.g., data packet 350) that includes packet address data. The packet address data may include a destination address corresponding to an intended receiving device of the data packet. The packet address data may further include a source address corresponding to a source device of the data packet. The intended receiving device and the source device may be the master control board and/or at least one of the plurality of devices.

At (520), the method 500 may include determining, at the device, whether the packet address data matches device address data of the device. More particularly, the device address data may include a physical address corresponding to the pin location at which the daisy chain sequence is coupled to the master control board. In other words, the physical address is the address used to identify the particular device of the plurality of devices that is the intended receiving device of the data packet. As such, the method 500 may include determining, at the device, whether the destination address of the packet address data matches the physical address of the device address data.

At (530), the method 500 may include transmitting the data packet to an adjacent device based, at least in part, on whether the packet address data matches the device address data at (520). More particularly, in response to determining whether the packet address data matches the device address data of the device at (520), the device may transmit the data packet received at (510) to an adjacent device that is proximate to the device along the daisy chain sequence. For instance, when the destination address of the data packet matches the physical address of the device, the device may generate and transmit a response packet to an up-chain device along the daisy chain sequence.

As used herein, “up-chain device” corresponds to any device and/or control board in an up-chain direction (e.g., up-chain direction U) from each device and/or control board of the data routing platform. In some embodiments, such as the data routing platform 300 depicted in FIG. 6, the master control board (e.g., master control board 302) may define a terminal end to the up-chain direction defined by the daisy chain sequence. Put differently, the master control board 302 is an up-chain device to every other device in the data routing platform 300.

On the other hand, when the destination address of the data packet does not match the physical address of the device, the device may transmit the data packet with updated packet address data to a down-chain device along the daisy chain sequence. As used herein, “down-chain device” corresponds to any device and/or control board in a down-chain direction (e.g., down-chain direction D) from each device and/or control board of the data routing platform. In some embodiments, such as the data routing platform 300 depicted in FIG. 6, the last node (e.g., device 306C) may define a terminal end to the down-chain direction defined by the daisy chain sequence. Put differently, the device 306C (e.g., the last node) is a down-chain device to every other device and/or control board in the data routing platform 300 of FIG. 6.

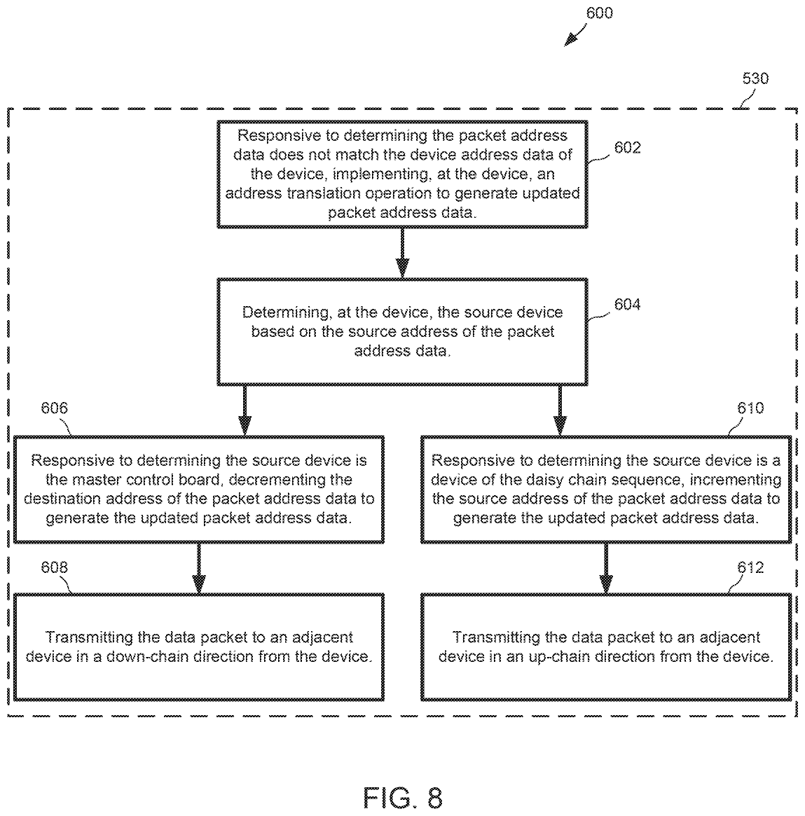

As an illustrative example, FIG. 8 depicts a flow chart diagram of an example method 600 for transmitting the data packet to an adjacent device based, at least in part, on determining the packet address data does not match the device address data of the device at (520). FIG. 8 depicts example method steps for purposes of illustration and discussion. Those of ordinary skill in the art, using the disclosures provided herein, will understand that the methods described in the present disclosure may be adapted, modified, include steps not illustrated, omitted, and/or rearranged without deviating from the scope of the present disclosure.

At (602), responsive to determining the packet address data does not match the device address data of the device at (520), the method 600 may include implementing, at the device, an address translation operation to generate updated packet address data. More particularly, because the destination address of the packet address data does not match the physical address of the device, the device that received the data packet at (510) is not the intended receiving device of the data packet. As such, the device may perform address translation operations to generate updated packet address data (e.g., updated destination address, updated source address) for the data packet.

At (604), the method 600 may include determining, at the device, the source device based on the source address of the packet address data. More particularly, in order to correctly generate the updated packet address data, the device must first determine the source device of the data packet. The device may do this in any suitable manner, such as by determining the source device based on the source address of the packet address data. Additionally and/or alternatively, the device may determine the source device based at least in part on whether the data packet was delivered (e.g., at (510)) from an up-chain device or a down-chain device. If the data packet was delivered from an up-chain device, the source device may be the master control board. Conversely, if the data packet was delivered from a down-chain device, the source device may be another device in the daisy chain sequence.

At (606), responsive to determining the source device is the master control board at (604), the method 600 may include decrementing, at the device, the destination address of the packet address data to generate the updated packet address data. More particularly, after identifying the master control board as the source device, the device may decrement the destination address of the packet address data to generate the updated packet address data, which includes updated packet address data (e.g., an updated destination address). For instance, the device may decrement the destination address in a similar manner as described above with reference to FIG. 6 (e.g., at 402).

At (608), responsive to decrementing the destination address of the packet address data at (606), the method 600 may include transmitting the data packet to an adjacent device in a down-chain direction from the device. More particularly, after decrementing the destination address of the packet address data, the device may transmit the data packet, which includes the updated destination address, to a down-chain device. For instance, the device may transmit the data packet having the updated packet address data to a down-chain device in a similar manner as described above with reference to FIG. 6 (e.g., at 404). Following receipt of the data packet, the receiving down-chain device may return to (510) and perform the data routing operations (e.g., of methods 500, 600, 700) described herein with reference to FIGS. 7-9.

At (610), responsive to determining the source device is a device of the daisy chain sequence at (604), the method 600 may include incrementing, at the device, the source address of the packet address data to generate the updated packet address data. More particularly, after identifying a different device in the daisy chain sequence as the source device, the device may increment the source address of the packet address data to generate the updated packet address data, which includes updated packet address data (e.g., an updated source address). For instance, the device may increment the source address in a similar manner as described above with reference to FIG. 6 (e.g., at 410).

At (612), responsive to incrementing the source address of the packet address data at (610), the method 600 may include transmitting the data packet to an adjacent device in an up-chain direction from the device. More particularly, after incrementing the source address of the packet address data, the device may transmit the data packet, which includes the updated source address, to an up-chain device. For instance, the device may transmit the data packet having the updated packet address data to an up-chain device in a similar manner as described above with reference to FIG. 6 (e.g., at 412). Following receipt of the data packet, the receiving up-chain device may return to (510) and perform the data routing operations (e.g., of methods 500, 600, 700) described herein with reference to FIGS. 7-9.

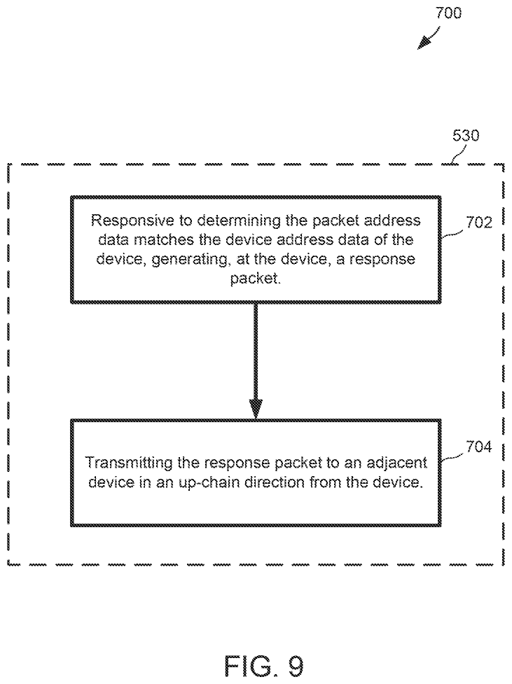

As another illustrative example, FIG. 9 depicts a flow chart diagram of an example method 700 for transmitting the data packet to an adjacent device based, at least in part, on determining the packet address data matches the device address data of the device at (520). FIG. 9 depicts example method steps for purposes of illustration and discussion. Those of ordinary skill in the art, using the disclosures provided herein, will understand that the methods described in the present disclosure may be adapted, modified, include steps not illustrated, omitted, and/or rearranged without deviating from the scope of the present disclosure.

At (702), responsive to determining the destination address of the packet address data matches the physical address of the device address data at (520), the method 700 may include generating, at the device, a response packet comprising response packet data. More particularly, because the destination address of the packet address matches the physical address of the device, the device that received the data packet at (510) is the intended receiving device of the data packet. As such, the intended receiving device may generate a response packet having a similar structure to the data packet 350 discussed above with reference to FIG. 5.

At (704), responsive to generating the response packet at (702), the method 700 may include transmitting the response packet to an adjacent device in an up-chain direction from the device. More particularly, the device may transmit the response packet generated at (702) to an adjacent up-chain device. As noted above, an “up-chain device” is a device in the up-chain direction (e.g., direction moving towards the master control board) along the daisy chain sequence. Following receipt of the response packet, the receiving up-chain device may return to (510) and perform the data routing operations (e.g., of methods 500, 600, 700) described herein with reference to FIGS. 7-9.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for operating a data routing platform of a home appliance, the data routing platform comprising a plurality of devices communicatively coupled to a master control board, the method comprising:
receiving, at a device of the plurality of devices, a data packet, the data packet comprising packet address data;
determining, at the device, whether the packet address data matches device address data of the device; and
responsive to determining the packet address data does not match the device address data of the device, implementing, at the device, an address translation operation to generate updated packet address data.

2. The computer-implemented method of claim 1, wherein the plurality of devices are communicatively coupled in a daisy chain topology to form a daisy chain sequence, the daisy chain sequence being coupled to the master control board at a pin location of the master control board.

3. The computer-implemented method of claim 2, wherein:
the packet address data comprises a destination address corresponding to an intended receiving device of the data packet and a source address corresponding to a source device of the data packet, the intended receiving device and the source device being at least one of the plurality of devices or the master control board; and
the device address data comprises a physical address corresponding to the pin location at which the daisy chain sequence is coupled to the master control board.

4. The computer-implemented method of claim 3, wherein determining whether the packet address data matches the device address data of the device comprises:
determining, at the device, whether the destination address of the packet address data matches the physical address of the device address data.

5. The computer-implemented method of claim 4, further comprising:
responsive to determining the destination address of the packet address data matches the physical address of the device address data, generating, at the device; and
responsive to generating the response packet, transmitting the response packet to an adjacent device in an up-chain direction from the device,
wherein the up-chain direction is a direction moving towards the master control board along the daisy chain sequence.

6. The computer-implemented method of claim 4, wherein implementing the address translation operation comprises:
responsive to determining the destination address of the packet address data does not match the physical address of the device address data, determining, at the device, the source device based on the source address of the packet address data.

7. The computer-implemented method of claim 6, wherein implementing the address translation operation further comprises:
responsive to determining the source device is the master control board, decrementing, at the device, the destination address of the packet address data to generate the updated packet address data, the updated packet address data comprising an updated destination address of the data packet; and
responsive to decrementing the destination address of the packet address data, transmitting the data packet to an adjacent device in a down-chain direction from the device, the data packet comprising the updated packet address data,
wherein the down-chain direction is a direction moving away from the master control board along the daisy chain sequence.

8. The computer-implemented method of claim 6, wherein implementing the address translation operation further comprises:
responsive to determining the source device is a device of the daisy chain sequence, incrementing, at the device, the source address of the packet address data to generate the updated packet address data, the updated packet address data comprising an updated source address of the data packet; and
responsive to incrementing the source address of the packet address data, transmitting the data packet to an adjacent device in an up-chain direction from the device, the data packet comprising the updated packet address data,
wherein the up-chain direction is a direction moving towards the master control board along the daisy chain sequence.

9. The computer-implemented method of claim 2, wherein the data routing platform further comprises a network interface, the network interface coupling the daisy chain sequence to the master control board at the pin location of the master control board.

10. The computer-implemented method of claim 1, wherein each of the plurality of devices is a circuit board comprising identical hardware and identical firmware.

11. A data routing platform for a home appliance, comprising:
a master control board coupled to a network interface;
a plurality of devices coupled in a daisy chain topology to form a daisy chain sequence, the daisy chain sequence being communicatively coupled to the master control board at a pin location of the master control board via the network interface, each device of the plurality of devices configured to perform data routing operations, the data routing operations comprising, for each device of the plurality of devices:
receiving a data packet comprising packet address data, the packet address data comprising a destination address corresponding to an intended receiving device of the data packet and a source address corresponding to a source device of the data packet;
determining whether the destination address of the packet address data matches device address data corresponding to the device, the device address data comprising a physical address corresponding to the pin location at which the daisy chain sequence is coupled to the master control board; and
responsive to determining the destination address of the address data does not match the physical address of the device address data, implementing an address translation operation to generate updated packet address data.

12. The data routing platform of claim 11, wherein the address translation operation comprises, for each device of the plurality of devices:
responsive to determining the destination address of the packet address data does not match the physical address of the device address data, determining the source device based on the source address of the packet address data;
responsive to determining the source device is the master control board, decrementing the destination address of the packet address data to generate the updated packet address data, the updated packet address data comprising an updated destination address of the data packet; and
responsive to decrementing the destination address of the packet address data, transmitting the data packet to an adjacent device in a down-chain direction from the device, the data packet comprising the updated packet address data,
wherein the down-chain direction is a direction moving away from the master control board along the daisy chain sequence.

13. The data routing platform of claim 11, wherein the address translation operation comprises, for each device of the plurality of devices:
responsive to determining the destination address of the packet address data does not match the physical address of the device address data, determining the source device based on the source address of the packet address data;
responsive to determining the source device is a device of the daisy chain sequence, incrementing the source address of the packet address data to generate the updated packet address data, the updated packet address data comprising an updated source address of the data packet; and
responsive to incrementing the source address of the packet address data, transmitting the data packet to an adjacent device in an up-chain direction from the device, the data packet comprising the updated packet address data,
wherein the up-chain direction is a direction moving towards the master control board along the daisy chain sequence.

14. The data routing platform of claim 11, wherein the data routing operations further comprise, for each device of the plurality of devices:
responsive to determining the destination address of the packet address data matches the physical address of the device address data, generating a response packet;
responsive to generating the response packet, transmitting the response packet to an adjacent device in an up-chain direction from the device,
wherein the up-chain direction is a direction moving towards the master control board along the daisy chain sequence.

15. The data routing platform of claim 11, wherein each of the plurality of devices is a circuit board comprising identical hardware and identical firmware.

16. The data routing platform of claim 11, wherein the network interface is a Universal Asynchronous Receiver/Transmitter (UART).

17. The data routing platform of claim 16, wherein the data routing platform comprises a single UART.

18. The data routing platform of claim 16, wherein the UART is integral to the master control board.

19. An appliance, comprising:
a user interface comprising one or more user inputs; and
a data routing platform comprising:
a master control board coupled to a network interface;
a plurality of devices coupled in a daisy chain topology to form a daisy chain sequence, the daisy chain sequence being communicatively coupled to the master control board at a pin location of the master control board via the network interface, each device of the plurality of devices configured to perform data routing operations, the data routing operations comprising, for each device of the plurality of devices:
receiving a data packet comprising packet address data, the packet address data comprising a destination address corresponding to an intended receiving device of the data packet and a source address corresponding to a source device of the data packet;
determining whether the destination address of the packet address data matches device address data corresponding to the device, the device address data comprising a physical address corresponding to the pin location at which the daisy chain sequence is coupled to the master control board; and
responsive to determining the destination address of the address data does not match the physical address of the device address data, implementing an address translation operation to generate updated packet address data.

20. The appliance of claim 19, wherein the appliance is an induction cooktop appliance.
